(19) United States
(12) Patent Application Publication
(10) Pub. No.: US 2024/0302210 A1
(43) Pub. Date: Sep. 12, 2024

(54) METHOD OF PERFORMING COLOR CALIBRATION OF MULTISPECTRAL IMAGE SENSOR AND IMAGE CAPTURING APPARATUS

(71) Applicants: SAMSUNG ELECTRONICS CO., LTD., Suwon-si (KR); UNIST (ULSAN NATIONAL INSTITUTE OF SCIENCE AND TECHNOLOGY), Ulsan (KR)

(72) Inventors: Woo-Shik KIM, Suwon-si (KR); Youngshin KWAK, Ulsan (KR); Heejin CHOI, Suwon-si (KR); Jisu OHK, Ulsan (KR)

(73) Assignees: SAMSUNG ELECTRONICS CO., LTD., Suwon-si (KR); UNIST (ULSAN NATIONAL INSTITUTE OF SCIENCE AND TECHNOLOGY), Ulsan (KR)

(21) Appl. No.: 18/385,168

(22) Filed: Oct. 30, 2023

(30) Foreign Application Priority Data
Mar. 6, 2023 (KR) 10-2023-0029445

(51) Int. Cl. G01J 3/02; G01J 3/28

(52) U.S. Cl. CPC G01J 3/0297; G01J 3/2823; G01J 2003/2826; G01J 2003/2833; G01J 2003/2836; G01J 2003/284

(57) ABSTRACT

A method of performing color calibration of a multispectral image sensor (MIS) includes obtaining test measurement data of at least one color chart that is measured by a test MIS under at least one lighting environment, obtaining reference measurement data of the at least one color chart that is measured by a reference MIS under the at least one lighting environment, the reference MIS being calibrated in advance, and generating, based on the test measurement data and the reference measurement data, at least one transformation model configured to transform measurements between the test MIS and the reference MIS.

### CROSS-REFERENCE TO RELATED APPLICATION

This application is based on and claims priority under 35 U.S.C. § 119 to Korean Patent Application No. 10-2023-0029445, filed on Mar. 6, 2023, in the Korean Intellectual Property Office, the disclosure of which is incorporated by reference herein in its entirety.

### BACKGROUND

### 1. Field

The disclosure relates to a method of performing color calibration of a multispectral image sensor (MIS) and an image capturing apparatus. In particular, the disclosure relates to a method of performing color calibration of an MIS using a reference color calibration model of a reference MIS calibrated in advance.

### 2. Description of Related Art

One utilization purpose of an image sensor is to obtain light information, such as a spectrum, a luminance, a chromaticity, etc. In order to obtain accurate light information, a calibration (i.e., a process of converting measurements of an image sensor into light information) may be required.

In the related art, a method of deriving a calibration function by comparing measurements of an image sensor with known light information is used. Such calibration method in the related art requires a large number of measurements and image capturing operations to improve the calibration precision.

### SUMMARY

Provided is a method for performing color calibration of a multispectral image sensor (MIS) and an image capturing apparatus.

Additional aspects will be set forth in part in the description which follows and, in part, will be apparent from the description, or may be learned by practice of the presented embodiments of the disclosure.

According to an aspect of the disclosure, a method of performing color calibration of an MIS may include obtaining test measurement data of at least one color chart that is measured by a test MIS under at least one lighting environment, obtaining reference measurement data of the at least one color chart that is measured by a reference MIS under the at least one lighting environment, the reference MIS being calibrated in advance, and generating, based on the test measurement data and the reference measurement data, at least one transformation model configured to transform measurements between the test MIS and the reference MIS.

The test measurement data may include a test measurement data matrix comprising rows corresponding to channels of the test MIS and columns corresponding to color samples in the at least one color chart and the reference measurement data may include a reference measurement data matrix comprising rows corresponding to channels of the reference MIS and columns corresponding to the color samples of the at least one color chart.

The generating of the at least one transformation model may include calculating the at least one transformation model by multiplying the reference measurement data matrix by an inverse matrix of the test measurement data matrix.

The at least one transformation model may be an N×N matrix including rows corresponding to N channels in the reference MIS and columns corresponding to N channels of the test MIS.

The obtaining of the test measurement data may include obtaining measurement data of P pixels with respect to each of M color samples in the at least one color chart, and the test measurement data matrix is an N×(M*P) matrix may include rows corresponding to N channels in the MIS and columns corresponding to the P pixels in each of the M color samples of the at least one color chart.

The obtaining of the test measurement data may include obtaining average data of measurement data of P pixels with respect to each of M color samples in the at least one color chart and the test measurement data matrix is an N×M matrix may include rows corresponding to N channels in the MIS and columns corresponding to the M color samples of the at least one color chart.

The at least one lighting environment may include a first lighting environment and a second lighting environment, the obtaining of the test measurement data may include obtaining first test measurement data of the at least one color chart that is measured by the test MIS under the first lighting environment illuminated with a first illuminant, obtaining second test measurement data of the at least one color chart that is measured by the test MIS under the second lighting environment illuminated with a second illuminant, and generating the test measurement data matrix based on the first test measurement data and the second test measurement data, and the obtaining of the reference measurement data may include obtaining first reference measurement data of the at least one color chart that is measured by the reference MIS under the first lighting environment illuminated with the first illuminant, obtaining second reference measurement data of the at least one color chart that is measured by the reference MIS under the second lighting environment illuminated with the second illuminant, and generating the reference measurement data matrix based on the first reference measurement data and the second reference measurement data.

The first illuminant may be different from the second illuminant.

The at least one lighting environment may include Q lighting environments, the obtaining of the test measurement data may include measuring the at least one color chart using the test MIS under each of the Q lighting environments, the obtaining of the reference measurement data may include measuring the at least one color chart using the reference MIS under each of the Q lighting environments, and the at least one transformation model may include an (N*Q)×(N*Q) matrix including rows corresponding to the Q lighting environments and N channels of the reference MIS, and columns corresponding to the Q lighting environments and N channels of the test MIS.

The at least one transformation model may be generated using a neural network based on the test measurement data and the reference measurement data.

The obtaining of the test measurement data may include obtaining first test measurement data by measuring a first color chart provided at a first position in an image frame of the test MIS, and obtaining second test measurement data by measuring a second color chart provided at a second position in the image frame of the test MIS, the obtaining of the reference measurement data may include obtaining first reference measurement data by measuring the first color chart provided at the first position in an image frame of the reference MIS, and the generating of the at least one transformation model may include generating, based on the first test measurement data and the first reference measurement data, a first transformation model configured to transform between measurements corresponding to the first position of the test MIS and measurements corresponding to the first position of the reference MIS and generating, based on the second test measurement data and the first reference measurement data, a second transformation model configured to transform between measurements corresponding to the second position of the test MIS and measurements corresponding to the first position of the reference MIS.

The generating of the at least one transformation model may include generating a third transformation model corresponding to a third position that is different from the first position and the second position by interpolating the first transformation model and the second transformation model.

The method may include transforming measurement data measured by the test MIS using the at least one transformation model and obtaining calibrated color data from the measurement data that is transformed using a reference color calibration model of the reference MIS.

According to an aspect of the disclosure, a method of performing color calibration in a first MIS may include receiving measurement data measured by the first MIS, receiving a color calibration model that is generated based on a transformation model configured to transform between measurements of the first MIS and a reference MIS that is calibrated in advance and a reference color calibration model of the reference MIS, and performing color calibration of the measurement data based on the color calibration model.

The color calibration model may include the transformation model and the reference color calibration model, and the performing of the color calibration of the measurement data may include transforming the measurement data using the transformation model and performing the color calibration of the measurement data that is transformed using the reference color calibration model.

The transformation model may include an N×N matrix including rows corresponding to N channels in the reference MIS and columns corresponding to N channels of the first MIS.

The transformation model may include a neural network model configured to transform measurements between the first MIS and the reference MIS.

According to an aspect of the disclosure, an image apparatus for performing color calibration may include a first MIS, and at least one processor configured to receive measurement data measured by the first MIS, receive a color calibration model generated based on a transformation model configured to transform between measurements of the first MIS and a reference MIS that is calibrated in advance and a reference color calibration model of the reference MIS, and perform color calibration of the measurement data using the color calibration model.

The transformation model may include an N×N matrix including rows corresponding to N channels in the reference MIS and columns corresponding to N channels of the first MIS.

The transformation model may include a neural network model configured to transform measurements between the first MIS and the reference MIS.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a cross-sectional view illustrating a multispectral image sensor (MIS) according to some embodiments;

FIGS. 2A and 2B are block diagrams illustrating an image capturing apparatus according to some embodiments;

FIG. 3 is a diagram illustrating a wavelength spectrum of an RGB sensor according to some embodiments;

FIGS. 4 and 5 are diagrams illustrating wavelength spectrums of an MIS according to some embodiments;

FIG. 6 is a diagram illustrating a process of generating an image for each channel based on signals obtained from a plurality of channels of an MIS according to some embodiments;

FIG. 7 is a diagram illustrating a color calibration of a test MIS according to some embodiments;

FIG. 8 is a diagram illustrating a process of optimizing a color transformation matrix according to some embodiments;

FIG. 9 is a diagram illustrating a method of generating a transformation model for color calibration of a test MIS according to some embodiments;

FIG. 10 is a diagram illustrating a transformation model based on a neural network according to some embodiments;

FIG. 11 is a diagram illustrating a method of generating a transformation model for color calibration of a test MIS according to some embodiments;

FIG. 12 is a flowchart illustrating a method of performing color calibration of an MIS according to some embodiments;

FIG. 13 is a flowchart illustrating a method of performing color calibration of an MIS according to some embodiments;

FIG. 14 is a flowchart illustrating a method of performing color calibration of an MIS according to some embodiments;

FIG. 15 is a diagram illustrating images captured by a test MIS and a reference MIS according to some embodiments;

FIG. 16 is a block diagram illustrating an electronic apparatus according to some embodiments;

FIG. 17 is a block diagram illustrating a camera module included in the electronic apparatus of FIG. 16 according to some embodiments; and

FIGS. 18, 19, 20, 21, 22, 23, 24, 25, 26 and 27 are diagrams illustrating various examples of an electronic device to which an image capturing apparatus is applied according to some embodiments.

### DETAILED DESCRIPTION OF THE EMBODIMENTS

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

In the drawings, like reference numerals refer to like elements throughout and sizes of constituent elements may be exaggerated for convenience of explanation and the clarity of the specification. Also, embodiments described herein may have different forms and should not be construed as being limited to the descriptions set forth herein.

It will also be understood that when an element is referred to as being “on” or “above” another element, the element may be in direct contact with the other element or other intervening elements may be present. The singular forms include the plural forms unless the context clearly indicates otherwise. It should be understood that, when a part “comprises” or “includes” an element, unless otherwise defined, other elements are not excluded from the part and the part may further include other elements.

The use of the terms “a” and “an” and “the” and similar referents are to be construed to cover both the singular and the plural. The steps of all methods described herein can be performed in any suitable order unless otherwise indicated herein or otherwise clearly contradicted by context, and are not limited to the described order.

Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device,

The use of any and all examples, or exemplary language (e.g., “such as”) provided herein, is intended merely to better illuminate the disclosure and does not pose a limitation on the scope of the disclosure unless otherwise claimed.

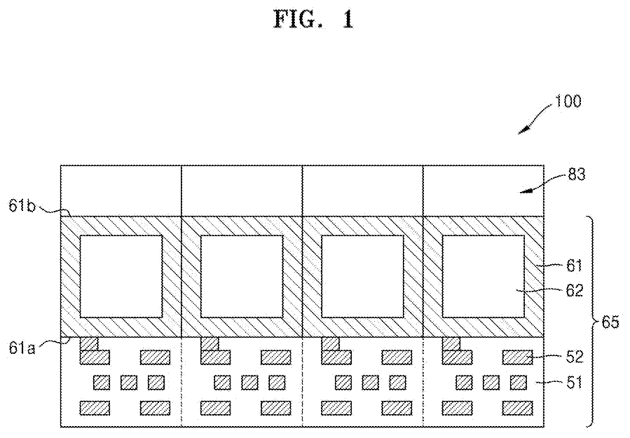

FIG. 1 is a cross-sectional view illustrating a multispectral image sensor (MIS) 100 according to some embodiments.

The MIS 100 of FIG. 1 may include, for example, a complementary metal oxide semiconductor (CMOS) image sensor or a charge coupled device (CCD) image sensor.

Referring to FIG. 1, the MIS 100 may include a pixel array 65 and a spectral filter 83 provided on the pixel array 65. The pixel array 65 may include a plurality of pixels that are two-dimensionally arranged, and the spectral filter 83 may include a plurality of resonators corresponding to the plurality of pixels. FIG. 1 shows an example in which the pixel array 65 includes four pixels and the spectral filter 83 includes four resonators, but the embodiments disclosed herein are not limited thereto.

Each pixel in the pixel array 65 may include a photodiode 62 that is a photoelectric conversion element and a driving circuit 52 for driving the photodiode 62. The photodiode 62 may be provided to be embedded in a semiconductor substrate 61. The semiconductor substrate 61 may include, for example, a silicon substrate. However, one or more embodiments are not limited thereto. A wiring layer 51 may be provided on a lower surface 61a of the semiconductor substrate 61, and the driving circuit 52, such as a metal-oxide-semiconductor field-effect transistor (MOSFET), etc. may be provided in the wiring layer 51.

The spectral filter 83 including the plurality of resonators is provided on an upper surface 61b of the semiconductor substrate 61. Each resonator may be provided to transmit light of a predetermined desired wavelength band. Each resonator may include reflective layers that are spaced apart from one another, and a cavity provided between the reflective layers. Each of the reflective layers may include, for example, a metal reflective layer or a Bragg reflective layer. Each cavity may be provided to resonate light of the predetermined desired wavelength band.

The spectral filter 83 may include one or more functional layers for improving transmittance of the light that is incident onto the photodiode 62 after passing through the spectral filter 83. The functional layer may include a dielectric layer or a dielectric pattern, of which a refractive index is adjusted. Also, the functional layer may include, for example, an anti-reflection layer, a condensing lens, a color filter, a short-wavelength absorption filter, or a long-wavelength absorption filter, etc. However, one or more embodiments are not limited to the above example.

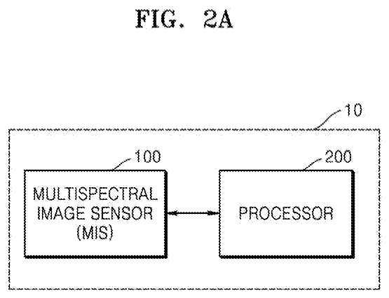

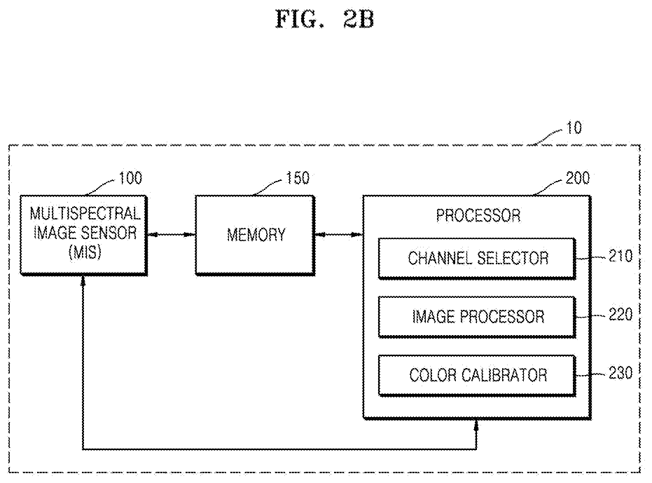

FIG. 2A is a block diagram illustrating an image capturing apparatus 10 according to some embodiments.

The image capturing apparatus 10 may include the MIS 100 and a processor 200. Although the image capturing apparatus 10 of FIG. 2 is depicted to only include elements related to the depicted embodiment, the image capturing apparatus 10 may further include other elements as will be understood by one of ordinary skill in the art from the disclosure herein.

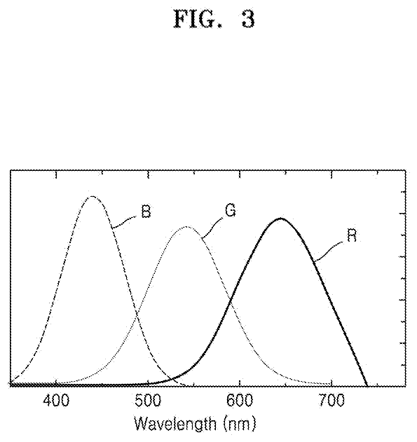

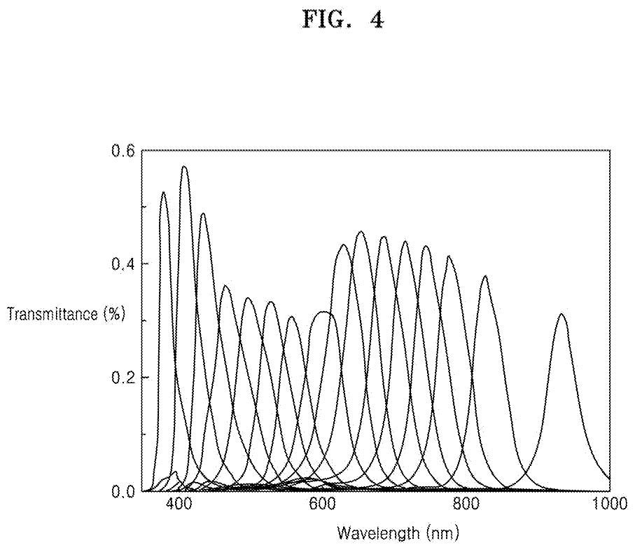

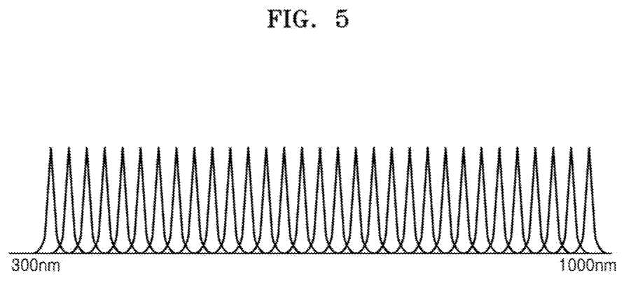

FIG. 3 is a diagram illustrating a wavelength spectrum of an RGB sensor according to some embodiments. FIGS. 4 and 5 are diagrams illustrating wavelength spectrums of an MIS according to some embodiments. The MIS 100 may include a sensor for sensing light of various kinds of wavelength bands. For example, the MIS 100 may sense the light of more wavelength bands than an RGB image sensor. For example, the RGB image sensor may include an R channel, a G channel, and a B channel, and may sense the light of wavelength bands respectively corresponding to the three channels (e.g., FIG. 3). The MIS 100 may include 16 channels or 31 channels as shown in FIGS. 4 and 5. However, one or more embodiments are not limited thereto, and the MIS 100 may include any number of channels, and in some embodiments, the MIS 100 may include a number of channels provided that the number is greater than 4.

The MIS 100 may adjust a peak wavelength, a bandwidth, and a transmission amount of light absorbed by each channel such that each channel may sense the light of a desired band. For example, the bandwidth of each channel in the MIS 100 may be set to be narrower than that of the R channel, the G channel, and the B channel. Also, a total bandwidth obtained by adding the band widths of all channels in the MIS 100 may include the total bandwidth of the RGB image sensor and may be greater than the bandwidth of the RGB image sensor. The image obtained by the MIS 100 may be a multispectral or hyperspectral image. The MIS 100 may obtain the image by dividing the relatively wide wavelength band including a visible ray band, an infrared ray band, an ultraviolet ray band, etc., into a plurality of channels.

The processor 200 controls overall operations of the image capturing apparatus 10. The processor 200 may include one processor core (single core) or a plurality of processor cores (multi-core). The processor 200 may process or execute programs and/or data stored on a memory. For example, the processor 200 may control the functions of the image capturing apparatus 10 by executing the programs stored in the memory.

FIG. 2B is a block diagram showing an image capturing apparatus 10 according to some embodiments.

The image capturing apparatus 10 may include the MIS 100, a memory 150, and the processor 200. The processor 200 may include a channel selector 210, an image processor 220, and a color calibrator 230. For convenience of description, the channel selector 210, the image processor 220, and the color calibrator 230 are components that are classified according to the operation of the processor 200, but the classification does not essentially denote that the corresponding components are physically separated. The corresponding components may correspond to an arbitrary combination of hardware and/or software included in the processor 200, and may be physically identical with or different from each other.

The memory 150 may store various data processed in the image capturing apparatus 10, and for example, the memory 150 may store the image obtained from the MIS 100. The memory 150 may include a line memory that sequentially stores images in line units, and may include a frame buffer storing entire image. Also, the memory 150 may store applications, drivers, etc., to be driven by the image capturing apparatus 10. The memory 150 may include a random-access memory (RAM) such as dynamic RAM (DRAM), static RAM (SRAM), etc., a read-only memory (ROM), an electrically erasable programmable read-only memory (EEPROM), compact disc (CD)-ROM (CD-ROM), Blu-ray or another optical disc storage, hard disk drive (HDD), solid state drive (SSD), or flash memory. However, examples of the memory are not limited thereto.

The memory 150 may be located outside the MIS 100 or may be integrated in the MIS 100. When the memory 150 is integrated in the MIS 100, the memory 150 may be integrated with a circuit component (e.g., the wiring layer 51 and/or the driving circuit 52 described above with reference to FIG. 1). The pixel portion (e.g., the semiconductor substrate 61 and/or the photodiode 62 described above with reference to FIG. 1) and the other portion (that is, the circuit portion and the memory 150) may each be a stack, and thus, two stacks may be integrated. In this case, the MIS 100 may be configured as one chip including two stacks. However, the disclosure is not limited thereto, and the MIS 100 may be configured as 3-stack including three layers of the pixel portion, the circuit portion, and the memory 150.

In addition, the circuit portion included in the MIS 100 may be the same as or different from the processor 200. When the circuit portion included in the MIS 100 is the same as the processor 200, the image capturing apparatus 10 may be the MIS 100 implemented as on-chip. Also, when the circuit portion included in the MIS 100 is different from the processor 200, the image capturing apparatus 10 may be implemented on-chip, provided that the processor 200 is disposed in the MIS 100. However, the disclosure is not limited thereto, and the processor 200 may be separately located outside the MIS 100.

The channel selector 210 may obtain channel signals that are output signals respectively corresponding to the channels of the MIS 100. The channel selector 210 may select at least some of the predetermined number of channels physically provided in the MIS 100, and may obtain the channel signals from the selected channels. For example, the channel selector 210 may obtain the channel signals from all of the predetermined number of channels physically provided in the MIS 100. Also, the channel selector 210 may obtain the channel signals by selecting some of the predetermined number of channels physically provided in the MIS 100.

The channel selector 210 may obtain the channel signals, of which the number is greater or less than the predetermined number of channels, by synthesizing or interpolating the channel signals obtained from the predetermined number of channels physically provided in the MIS 100. For example, the channel selector 210 may obtain the channel signals, the number of which is less than the predetermined number, by performing a binning on the pixels or channels of the MIS 100. Also, the channel selector 210 may obtain the channel signals, the number of which is greater than the predetermined number, by generating a new channel signal through the interpolation of the channel signals.

When the number of the obtained channel signals is decreased, each of the channel signals may correspond to a wide band, and thus, an intensity of the signal may increase and the noise may decrease. On the contrary, when the number of channel signals increases, a sensitivity of each channel signal may be decreased, but a precise image may be obtained based on a plurality of channel signals. As described above, because there is trade-off according to increase/decrease in the number of obtained channel signals, the channel selector 210 may obtain an appropriate number of channel signals according to application.

The image processor 220 may perform a basic image processing before or after storing the image or signal obtained by the MIS 100 in the memory 150. The basic image processing may include bad pixel correction, fixed pattern noise correction, crosstalk reduction, remosaicing, demosaicing, false color reduction, denoising, chromatic aberration correction, etc.

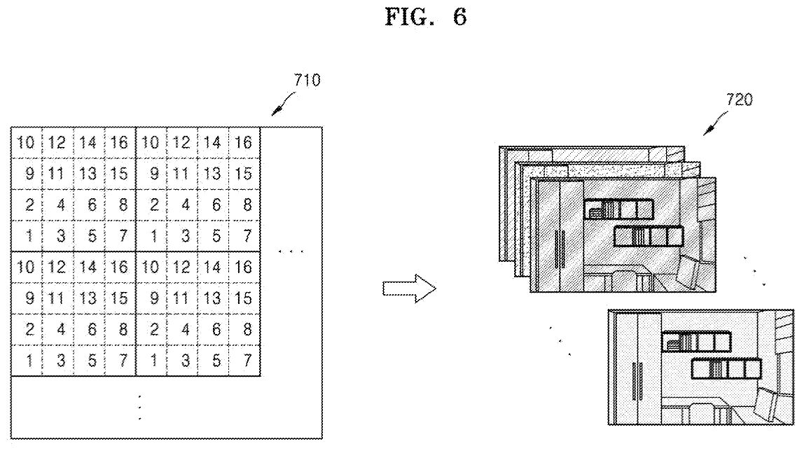

FIG. 6 is a diagram illustrating a process of generating an image for each channel based on signals obtained from a plurality of channels of an MIS according to some embodiments. The image processor 220 may generate the image for each channel by performing demosaicing on the channel signals and may perform the image processing on the image for each channel. Referring to FIG. 6, a raw image 710 obtained from the MIS and a channel image 720 for each channel after performing demosaicing are shown. In the raw image 710, one small square denotes one pixel, and the number in the square denotes a channel number. As shown from the channel number, FIG. 6 shows the image obtained by the MIS including 16 channels. The raw image 710 includes pixels corresponding to different channels, but the pixels of the same channel are collected through the demosaicing and the channel image 720 may be generated.

The calibration may denote a series of works for setting a relationship between a measurement value of a measuring instrument and a known corresponding value of a measurand. In order to perform a modeling of the direct relationship between measurement data of the image sensor and corresponding color data, many measurements may be required for accuracy of measurement data and accuracy in calibration. In an embodiment, for performing a simplified color calibration operation, the color calibrator 230 may use a reference color calibration model of a reference multi-spectral image sensor (reference MIS) calibrated in advance, instead of using the direct relationship between the measurement data of the MIS 100 and the corresponding color data. The color calibrator 230 may convert the measurement data of the MIS 100 using a transformation model that is obtained by modeling the relationship between the measurements of the reference MIS and the measurements of the MIS 100, and may apply the reference color calibration model of the reference MIS to the transformed measurement data. Also, the color calibrator 230 may perform the color calibration of the measurement data of the MIS 100 using the transformation model and a color calibration model based on the reference color calibration model.

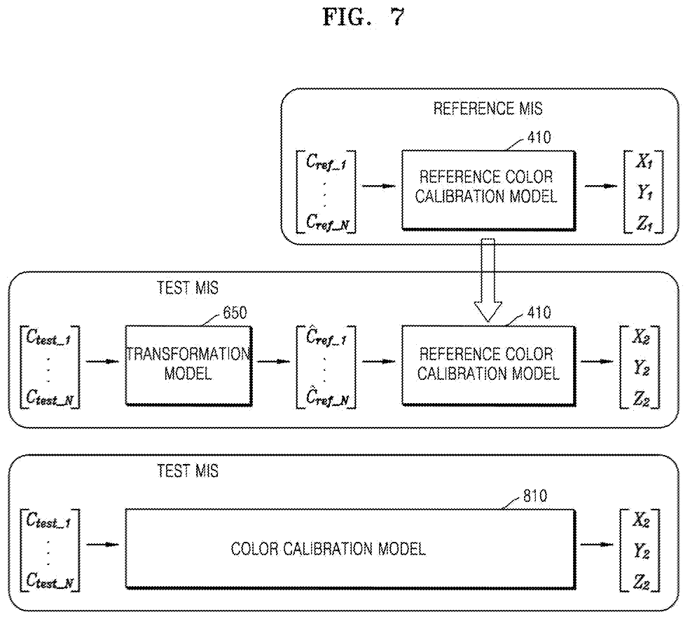

Hereinafter, the color calibration of the MIS according to the embodiments of the disclosure will be described in detail below with reference to FIGS. 7 to 14.

FIG. 7 is a diagram illustrating a color calibration of a test MIS according to some embodiments.

The reference MIS may be the MIS on which the color calibration is performed, and a test MIS may denote an MIS that is to perform the color calibration. The test MIS may have a spectral sensitivity that is different from the reference MIS. The reference MIS may have a reference color calibration model 410 that is obtained by modeling the relationship between the measurement data and corresponding color data.

The measurement data of the reference MIS may be transformed into the color data according to the reference color calibration model 410. For example, the channel signals (C_{ref_1}, . . . , C_{ref_N}) of the reference MIS with respect to a single pixel (i.e., the measurement data) may be transformed into XYZ signals (X₁, Y₁, Z₁) of a CIE XYZ color space (i.e., color data).

The reference color calibration model 410 may be a model for transforming the channel signals of the reference MIS into the color space. For example, the reference color calibration model 410 may be a color transformation matrix M_{C} of Equation (1) below.

$$[ \begin{matrix}{X}_{predict} \\ {Y}_{predict} \\ {Z}_{predict}\end{matrix} ] = {M}_{C} \cdot [ \begin{matrix}{C}_{ref \_ 1} \\ ⋮ \\ {C}_{ref \_ N}\end{matrix} ] \qquad ( 1 )$$

In Equation (1) above, C_{ref_n}(n=1, . . . , N) denotes a channel signal of the reference MIS and the left side denotes the XYZ signal in the CIE XYZ color space.

Otherwise, the reference color calibration model 410 may be M_{sRGB}·_{C} of Equation (2) below.

$$[ \begin{matrix}{R}_{s} \\ {G}_{s} \\ {B}_{s}\end{matrix} ] = {M}_{sRGB} \cdot {M}_{C} \cdot [ \begin{matrix}{C}_{ref \_ 1} \\ ⋮ \\ {C}_{ref \_ N}\end{matrix} ] \qquad ( 2 )$$

In Equation (2) above, C_{ref_n}(n=1, . . . , N) denotes a channel signal of the reference MIS, and the left side denotes an RGB signal of a standard RGB (sRGB) color space.

The color space for the reference color calibration model 410 may include various color spaces such as an ICtCp color space, etc., in addition to the CIE XYZ color space and the sRGB color space.

In addition, a color transformation matrix Mc may be obtained by reducing the chrominance based on a result of measuring or photographing various test colors, or by reconstructing a spectrum. For example, the color transformation matrix may be optimized such that the chrominance between a color value obtained using the color transformation matrix and an actual color value may be minimized.

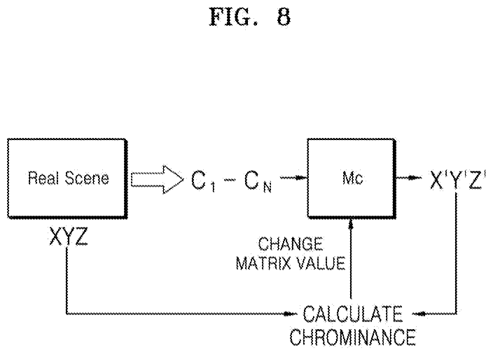

FIG. 8 is a diagram illustrating a process of optimizing a color transformation matrix according to some embodiments. Referring to FIG. 8 that describes the process of optimizing the color transformation matrix according to the embodiment, when a real scene is photographed by the reference MIS, a plurality of channel signals C₁ to C_{N} may be obtained. When an initial color transformation matrix Mc is applied to the plurality of channel signals C₁ to C_{N}, a predicted color value X′Y′Z′ may be obtained. A chrominance between an actual color value XYZ corresponding to the real scene and the predicted color value X′Y′Z′ may be calculated using equations such as CIELAB or CIEDE2000. The elements in the color transformation matrix Mc may be changed such that the calculated chrominance may be minimized using an optimization algorithm. As the above processes are repeated, the color transformation matrix may be optimized such that the actual color value may be accurately output when the channel signals are input.

Otherwise, the reference color calibration model 410 may be CMF·M_{S} of Equation (3) below.

$${M}_{C} \cdot [ \begin{matrix}{C}_{ref \_ 1} \\ ⋮ \\ {C}_{ref \_ N}\end{matrix} ] = CMF \cdot {M}_{S} \cdot [ \begin{matrix}{C}_{ref \_ 1} \\ ⋮ \\ {C}_{ref \_ N}\end{matrix} ] \qquad ( 3 )$$

In Equation (3) above, a matrix Ms may transform N channel signals into spectrum signals, and a matrix CMF may transform the spectrum signal into an XYZ signal in the CIE XYZ color space based on a CIE color matching function. In Equation (3) above, the matrix MCF may have a size of 3xL, 3 denotes that the matrix CMF has three wavelengths, (i.e., X, Y, and Z), and L denotes the number of samplings of the wavelength. In Equation (3) above, the matrix Mx may have a size of L×N.

The matrix Ms may have a relationship with a matrix T including spectrum information corresponding to t color samples and a channel signal matrix C measured with respect to t color samples using a reference MIS, according to Equation (4) below.

$$T = {M}_{S} C \qquad ( 4 )$$

Therefore, the matrix Ms may be calculated using Pseudo-inverse matrix as shown in Equation (5) below.

$${M}_{S} = T \cdot PINV ( C ) = [ \begin{matrix}{T}_{1 , 1} & … & {T}_{1 , t} \\ ⋮ & ⋱ & ⋮ \\ {T}_{L , 1} & … & {T}_{L , t}\end{matrix} ] \cdot PINV [ \begin{matrix}{C}_{1 , 1} & … & {C}_{1 , t} \\ ⋮ & ⋱ & ⋮ \\ {C}_{N , 1} & … & {C}_{N , t}\end{matrix} ] \qquad ( 5 )$$

N channel signals may be transformed into spectrum signals by the matrix Ms. There may be cases in which predicted color values are equal to each other even when detailed values of the spectrum signal are different. Therefore, when the color transformation is performed at the spectrum signal level using the optimized matrix Ms, more accurate color values may be obtained. The optimization of the matrix Ms may be similarly performed to the method described above with reference to FIG. 8, but the disclosure is not limited thereto.

Instead of an operation of setting the direct relationship between the measurement data of the test MIS and the corresponding color data for color calibration of the test MIS, an operation of setting the relationship between the measurement data of the test MIS and the measurement data of the corresponding reference MIS may be performed. In other words, the operation of setting the relationship between the channel signals of the test MIS and the channel signals of the corresponding reference MIS may be performed. To this end, an operation of generating a transformation model 650 for transforming the measurements between the test MIS and the reference MIS may be performed.

The measurement data of the test MIS may be transformed into the values that are expected to be measured by the reference MIS, according to the transformation model 650. The transformed measurement data may be transformed into color data by the reference color calibration model 410 of the reference MIS. For example, the channel signals (C_{test_1}, . . . , C_{test_N}) of the test MIS with respect to the single pixel are transformed by the transformation model 650, and the transformed channel signals (Ĉ_{ref_1}, . . . , Ĉ_{ref_N}) may be transformed into the XYZ signals (X₂, Y₂, Z₂) in the CIE XYZ color space.

A color calibration model 810 may be generated from the transformation model 650 and the reference color calibration model 410. When the transformation model 650 and the reference color calibration model 410 are matrix, the color calibration model 810 may be generated from a matrix product of the reference color calibration model 410 and the transformation model 650. The measurement data of the test MIS may be transformed into color data by the color calibration model 810. For example, the channel signals (C_{test_1}, . . . , C_{test_N}) of the test MIS with respect to the single pixel may be transformed into the XYZ signals (X₂, Y₂, Z₂) in the CIE XYZ color space by the color calibration model 810.

In the disclosure, because the reference color calibration model of the reference MIS is used for the color calibration of the test MIS, the color calibration operation for setting the direct relationship between the measurement data of the test MIS and the color data is not necessary. Therefore, the color calibration operation for the test MIS may be simplified. Also, by updating the reference color calibration model of the reference MIS, the performance of the test MIS based on the reference color calibration model of the reference MIS may be also updated.

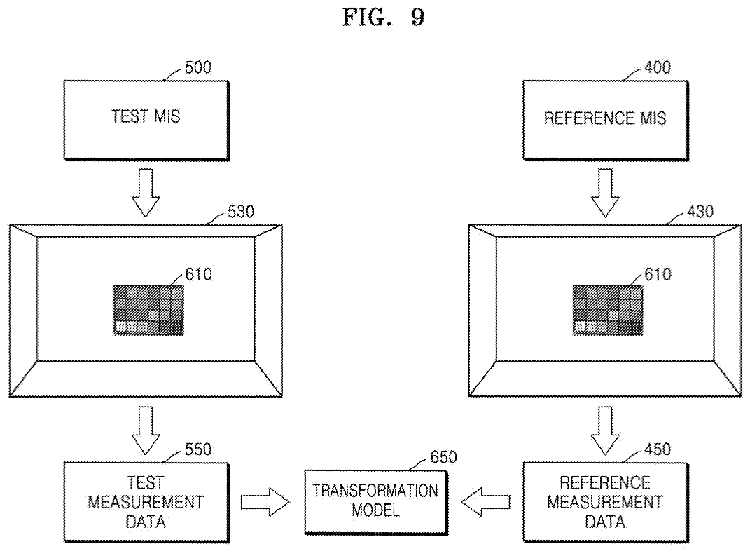

FIG. 9 is a diagram illustrating a method of generating a transformation model for color calibration of a test MIS 500 according to some embodiments.

Under a lighting environment, a color chart 610 may be photographed by the test MIS 500. Likewise, the color chart 610 may be photographed by a reference MIS 400 under the same lighting environment. A position of the color chart 610 in an image frame 530 of the test MIS 500 and a position of the color chart 610 in an image frame 430 of the reference MIS 400 may be the same as each other.

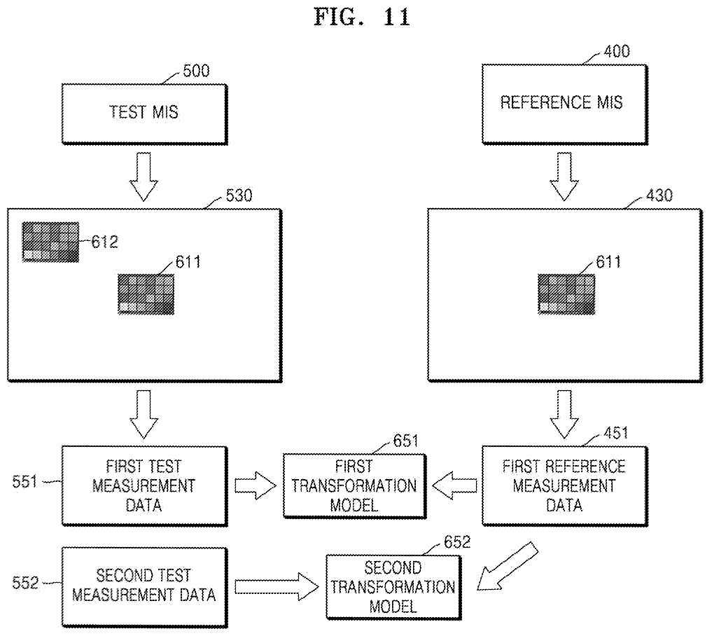

The color chart 610 may be located at a center region in each of the image frames 430 and 530. A chief ray angle (CRA) may vary depending on an angle of view of the MIS. Therefore, by photographing the color chart 610 to be located at the center region having the smallest CRA in each of the image frames 430 and 530, the measurement reliability may be improved. However, as described later with reference to FIG. 11, the color chart 610 may be photographed to be located at an edge region of the image frame 530.

The color chart 610 may be an object including color samples. The color samples may be selected as arbitrary colors for the color calibration. FIG. 9 shows the color chart 610 including 24 color samples, but the number of color samples is not limited thereto. The color chart 610 may be a ColorChecker. For example, the color chart 610 may include a Macbeth chart, but is not limited thereto.

The color chart 610 may be arranged in a lighting booth. The lighting booth may have a light environment determined by an illuminant. A plurality of illuminants may be arranged in the lighting booth. For example, a standard illuminant may be used as the illuminant. For example, a lighting of D50, D55, D65, D75, D93, A, B, C, E, and F series, or a typical light-emitting diode (LED) lamp may be used as the illuminant.

Test measurement data 550 may be obtained from the measurement of the color chart 610 via the test MIS 500. The test measurement data 550 according to the embodiment may be expressed as text measurement data matrix as shown in Equation (6) below.

$$[ \begin{matrix}{C}_{test \_ 1 , 1} & … & {C}_{test \_ 1 , \text{?}} \\ ⋮ & {C}_{test \_ i , \text{?}} & ⋮ \\ {C}_{test \_ \text{?} , 1} & … & {C}_{test \_ \text{?}}\end{matrix} ] \qquad ( 6 )$$

$$\text{?} \text{indicates text missing or illegible when filed}$$

The test measurement data matrix may be an array of channel signals of the test MIS 500 with respect to each color sample in the color chart 610. In the test measurement data matrix, rows correspond to the channels of the test MIS 500 and columns correspond to the color samples in the color chart 610. That is, in the test measurement data matrix, a first column denotes channel signals corresponding to a first color sample, and a first row denotes first channel signals with respect to the color samples. For example, when the test MIS 500 includes N channels and the color chart 610 includes M color samples, in Equation (6) above, I denotes N, J denotes M, C_{test_i,j} denotes an i-th channel signal of the test MIS 500 corresponding to a j-th color sample, and the test measurement data matrix is N×M matrix. For example, when the test MIS 500 includes 16 channels and the color chart 610 includes 24 color samples, the test measurement data matrix is a 16×24 matrix.

Alternatively, the test measurement data matrix may be an array of channel signals of the test MIS 500 with respect to each of a plurality of pixels in the color sample in the color chart 610. The plurality of pixels may be any pixels arranged in any region of each color sample. For example, the plurality of pixels may include 8×8 pixels arranged in the center region of each color sample, but are not limited thereto. In the test measurement data matrix, rows correspond to the channels of the test MIS 500 and columns correspond to the plurality of pixels of the color samples in the color chart 610. That is, in the test measurement data matrix, the first column may denote channel signals corresponding to the first pixel of the first color sample, and the second column may denote channel signals corresponding to the second pixel of the first color sample. For example, when the test MIS 500 includes N channels, the color chart 610 includes M color samples, and P pixels are selected from each color sample, in Equation (6) above, I denotes N, J denotes M*P, C_{test_i,j} denotes an i-th channel signal of the test MIS 500 corresponding to the j-th pixels in the color samples, and the test measurement data matrix is N×(M*P) matrix. For example, when the test MIS 500 includes 16 channels, the color chart 610 includes 24 color samples, and 64 pixels are selected from each color sample, the test measurement data matrix is 16×(24*64) matrix.

Instead of the channel signals of the test MIS 500 with respect to each of the plurality of pixels, average channel signals of the test MIS 500 with respect to the plurality of pixels may be used. For example, when the test MIS 500 includes 16 channels, the color chart 610 includes 24 color samples, 64 pixels are selected from each color sample, and average channel signals with respect to 64 pixels are used, the test measurement data matrix is 16×24 matrix.

The reference measurement data 450 may be expressed as a reference measurement data matrix as shown in Equation (7) below.

$$[ \begin{matrix}{C}_{ref \_ 1 , 1} & … & {C}_{ref \_ 1 , \text{?}} \\ ⋮ & {C}_{ref \_ i , \text{?}} & ⋮ \\ {C}_{ref \_ \text{?} , 1} & … & {C}_{ref \_ \text{?}}\end{matrix} ] \qquad ( 7 )$$

$$\text{?} \text{indicates text missing or illegible when filed}$$

In Equation (7) above, C_{ref_i,j} denotes the channel signal of the reference MIS 400. The reference measurement data matrix may be configured in the same manner as that of the test measurement data matrix.

The transformation model 650 based on the test measurement data 550 and the reference measurement data 450 may be calculated by Equation (8) below.

$${[ \begin{matrix}{C}_{ref \_ 1 , 1} & … & {C}_{ref \_ 1 , \text{?}} \\ ⋮ & {C}_{ref \_ i , \text{?}} & ⋮ \\ {C}_{ref \_ \text{?} , 1} & … & {C}_{ref \_ \text{?}}\end{matrix} ] [ \begin{matrix}{C}_{test \_ 1 , 1} & … & {C}_{test \_ 1 , \text{?}} \\ ⋮ & {C}_{test \_ i , j} & ⋮ \\ {C}_{test \_ \text{?} , 1} & … & {C}_{test \_ \text{?}}\end{matrix} ]}^{- 1} \qquad ( 8 )$$

$$\text{?} \text{indicates text missing or illegible when filed}$$

Equation (8) above denotes a product of the reference measurement data matrix and an inverse matrix of the test measurement data matrix. When the test measurement data matrix is not a square matrix, a pseudo inverse of the test measurement data matrix may be used in Equation (8) above.

Because the rows of the test measurement data matrix and the rows of the reference measurement data matrix respectively correspond to the channels of the test MIS 500 and the channels of the reference MIS 400, the transformation model 650 may be a matrix including the rows corresponding to the channels of the reference MIS 400 and the columns corresponding to the channels of the test MIS 500. For example, the transformation model 650 may be an N×N matrix including the rows corresponding to the N channels of the reference MIS 400 and the columns corresponding to the N channels of the test MIS 500. For example, when the test MIS 500 and the reference MIS 400 respectively include 16 channels, the transformation model 650 is a 16×16 matrix.

The photographing of the test MIS 500 and the reference MIS 400 may be performed under various lighting environments. The photographing may be performed in a first lighting environment using a first illuminant and may be also performed in a second lighting environment using a second illuminant. In the first lighting environment, first test measurement data may be obtained from the photographing by the test MIS 500 and the first reference measurement data may be obtained from the photographing by the reference MIS 400. Likewise, in the second lighting environment, second test measurement data and second reference measurement data may be obtained by the test MIS 500 and the reference MIS 400.

The test measurement data may be obtained by concatenating the first test measurement data and the second test measurement data. Also, the reference measurement data may be obtained by concatenating the first reference measurement data and the second reference measurement data. For example, when the photographing is performed under each of Q lighting environments, the test MIS 500 and the reference MIS 400 each include N channels, and the color chart 610 includes M color samples, I may denote N*Q and J may denote M in Equations (6) and (7) above. The transformation model 650 may be obtained based on the concatenated test measurement data and concatenated reference measurement data. For example, when the photographing is performed in each of Q lighting environments and the test MIS 500 and the reference MIS 400 each include N channels, the transformation model 650 may be a (N*Q)×(N*Q) matrix according to Equation (8) above. For example, when the photographing is performed in each of the two lighting environments, the test MIS 500 and the reference MIS 400 each include 16 channels, and the color chart 610 includes 24 color samples, the test measurement data matrix and the reference measurement data matrix are (16*2)×24 matrix and the transformation model 650 is (16*2)×(16*2) matrix.

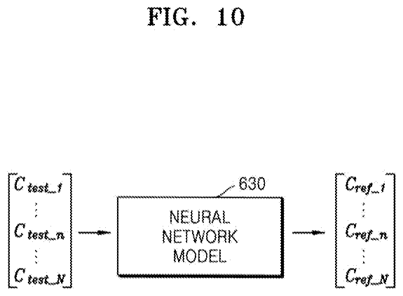

FIG. 10 is a diagram illustrating a transformation model based on a neural network according to some embodiments. In another embodiment, the transformation model 650 may be generated based on a neural network. The neural network may include a deep neural network or a shallow neural network. The neural network may be an artificial neural network including an input layer, at least one hidden layer, and an output layer. Referring to FIG. 10, the transformation model 650 may include a neural network model 630 that is trained to receive the input of channel signals of the N channels in the test MIS 500 and output N channel signals of the reference MIS 400. Training of the neural network model 630 may be performed using the test measurement data 550 and the reference measurement data 450. The test measurement data 550 may be a one-dimensional matrix of the channel signals of the test MIS 500. The test measurement data 550 may be expressed by Equation (9) below.

$$[ \begin{matrix}{C}_{test \_ 1} \\ ⋮ \\ {C}_{test \_ n} \\ ⋮ \\ {C}_{test \_ N}\end{matrix} ] \qquad ( 9 )$$

In Equation (9) above, C_{test_n} denotes a channel signal of an n-th channel in the test MIS 500 and N denotes the number of channels in the test MIS 500.

The reference measurement data 450 may be a one-dimensional matrix of the channel signals of the reference MIS 400. The reference measurement data 450 may be expressed by Equation (10) below.

$$[ \begin{matrix}{C}_{ref \_ 1} \\ ⋮ \\ {C}_{ref \_ n} \\ ⋮ \\ {C}_{ref \_ N}\end{matrix} ] \qquad ( 10 )$$

In Equation (10) above, C_{ref_n} denotes a channel signal of an n-th channel in the reference MIS 400 and N denotes the number of channels in the reference MIS 400.

For sufficient training data, channel signals for each of the color samples of the color chart 610, channel signals for each of the plurality of pixels in the color samples of the color chart 610, and channel signals obtained from different lighting environments may be used.

FIG. 11 is a diagram illustrating a method of generating a transformation model for color calibration of a test MIS 500 according to some embodiments.

As the angle of view of the MIS increases, the CRA may increase. Accordingly, a measurement value of the pixel may vary depending on the position of the pixel in one image frame. Considering this, the transformation model may be generated according to the location in the image frame 530. To this end, the photographing may be performed such that a first color chart 611 and a second color chart 612 are located at different positions in the image frame 530. For example, the first color chart 611 may be at a first position and the second color chart 612 may be at a second position in the image frame 530. For example, the first color chart 611 may be located at the center region and the second color chart 612 may be located at the edge region in the image frame 530. Accordingly, first test measurement data 551 of the first color chart 611 and second test measurement data 552 of the second color chart 612 measured by the test MIS 500 may be obtained.

In the image frame 430, the first color chart 611 may be at the first position as in the image frame 530. For example, in the image frame 430, the first color chart 611 may be located at the center region. Accordingly, first reference measurement data 451 of the first color chart 611 measured by the reference MIS 400 may be obtained.

The description with reference to FIGS. 9 and 10 may be applied to the obtaining of the first and second test measurement data 551 and 552 and the first reference measurement data 451.

A first transformation model 651 may be generated based on the first test measurement data 551 and the first reference measurement data 451. The description provided above with reference to FIGS. 9 and 10 may be applied to the generation of the first transformation model 651.

A second transformation model 652 may be generated based on the second test measurement data 552 and the first reference measurement data 451. The description provided above with reference to FIGS. 9 and 10 may be applied to the generation of the second transformation model 652.

In the image frame 530, a transformation model corresponding to a position other than the first and second positions may be generated in the same manner as that of the first and second transformation models 651 and 652. Otherwise, the transformation model corresponding to the different position than the first and second positions may be generated by interpolating the first transformation model 651 and the second transformation model 652. For example, by interpolating the first transformation model 651 and the second transformation model 652, a third transformation model corresponding to a third position between the first and second positions may be generated in the image frame 530. For example, when the first transformation model 651 is a matrix A and the second transformation model 652 is a matrix B, the third transformation model may be generated by interpolating the matrix A and the matrix B for each element. Accordingly, the transformation model for every position may be generated without performing the measurement of the color chart for every position in the image frame 530.

Alternatively, the second transformation model 652 may be generated based on the first test measurement data 551 and the second test measurement data 552. That is, the second transformation model 652 may be a transformation model for transformation between measurement values of the color charts at different positions in the image frame 530 of the test MIS 500, not for the transformation between the measurement values of the test MIS 500 and the reference MIS 400. The description provided above with reference to FIGS. 9 and 10 may be applied to the generation of the second transformation model 652, except that the test measurement data is used instead of the reference measurement data. In this case, a fourth transformation model may be generated for the transformation between the measurement value corresponding to the second position of the test MIS 500 and the measurement value corresponding to the first position of the reference MIS 400. The fourth transformation model may be generated based on the first and second transformation models 651 and 652. For example, when the first transformation model 651 is a matrix A and the second transformation model 652 is a matrix B, the fourth transformation model may be A*B (i.e., the product of the matrix A and the matrix B).

The transformed measurement data may be obtained by applying the transformation model according to the embodiments of the disclosure to the measurement data of the MIS. When the transformation model is a matrix, the transformed measurement data may be obtained by multiplying the measurement data by the transformation model. When the transformation model is a neural network model, the transformed measurement data may be obtained from the output from the transformation model with respect to the measurement data.

The transformed measurement data is measurement data that is expected to be measured by the reference MIS. Therefore, more accurate analysis result may be obtained using the transformed measurement data in the image analysis of various technical fields. For example, the transformed measurement data may be used in the image analysis for material analysis, skin analysis, food freshness measurement, product foreign matter analysis, product defect analysis, soil analysis, biometrics, etc.

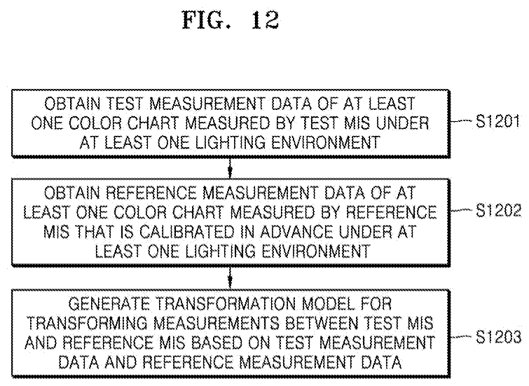

FIG. 12 is a flowchart illustrating a method of performing color calibration of an MIS according to some embodiments.

The flowchart of FIG. 12 may illustrate the method of generating a transformation model between the test MIS and the reference MIS for the color calibration of the test MIS. The method of FIG. 12 may be performed by a processor of an electronic device for the color calibration. Even when omitted, the above description provided with reference to FIGS. 1 to 11 may be applied to the method of FIG. 12.

In operation S1201, the processor may obtain test measurement data of at least one color chart measured by the test MIS in at least one lighting environment. The test measurement data may be an array of the channel signals of the test MIS. Alternatively, the test measurement data may be an array of the channel signals of the test MIS with respect to the color samples in the color chart. The test measurement data may be expressed as a test measurement data matrix.

In operation S1202, the processor may obtain reference measurement data of at least one color chart measured by the reference MIS that is calibrated in advance in at least one lighting environment. The reference measurement data may be an array of the channel signals of the reference MIS, corresponding to the test measurement data. The reference measurement data may be expressed as a reference measurement data matrix.

In operation S1203, the processor may generate a transformation model for transforming the measurements between the test MIS and the reference MIS, based on the test measurement data and the reference measurement data. The transformation model may be calculated from the product of the reference measurement data matrix and an inverse matrix of the test measurement data matrix. Alternatively, the transformation model may be a neural network model that is trained to output reference measurement data by receiving an input of the test measurement data.

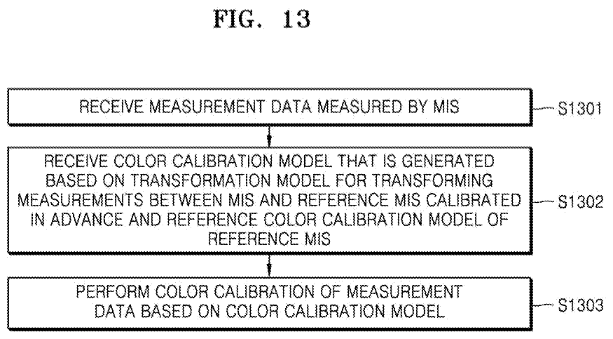

FIG. 13 is a flowchart illustrating a method of performing color calibration of an MIS according to some embodiments.

FIG. 13 is a flowchart illustrating a method of performing color calibration of the MIS 100 in the image capturing apparatus 10. The MIS 100 may be a test MIS of which the transformation model with the reference MIS is obtained. Even when omitted, the above description provided with reference to FIGS. 1 to 12 may be applied to the method of FIG. 13.

In operation S1301, the processor 200 may receive measurement data measured by the MIS 100. The measurement data may be the measurement data about an arbitrary scene or an object captured while using the image capturing apparatus 10.

In operation S1302, the processor 200 may receive a color calibration model that is generated based on the transformation model for transforming the measurement values between the MIS and the reference MIS calibrated in advance, and a reference color calibration model of the reference MIS. That is, the color calibration model may be generated based on the transformation model and the reference color calibration model of the reference MIS. The color calibration model may include the transformation model and the reference color calibration model. When the transformation model and the color calibration model are matrixes, the color calibration model may be the matrix product of the reference color calibration model and the transformation model. The color calibration model may be obtained in advance according to the embodiments of the present disclosure. The color calibration model may be stored in the memory 150. The processor 200 may receive the color calibration model from the memory 150.

In operation S1303, the processor 200 may perform the color calibration of the measurement data based on the color calibration model. When the color calibration model is a matrix, the processor 200 may obtain color data with respect to the measurement data by multiplying the measurement data by the color calibration model.

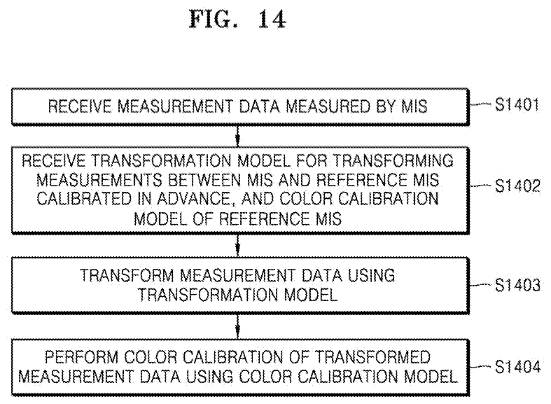

FIG. 14 is a flowchart illustrating a method of performing color calibration of an MIS according to some embodiments.

FIG. 14 is a flowchart illustrating a method of performing color calibration of the MIS 100 in the image capturing apparatus 10. The MIS 100 may be a test MIS of which the transformation model with the reference MIS is obtained. Even when omitted, the above description provided with reference to FIGS. 1 to 13 may be applied to the method of FIG. 14.

In operation S1401, the processor 200 may receive measurement data measured by the MIS 100. The measurement data may be the measurement data about an arbitrary scene or an object captured while using the image capturing apparatus 10.

In operation S1402, the processor 200 receives the transformation model for transforming the measurements between the MIS and the reference MIS that is calibrated in advance, and the reference color calibration model of the reference MIS. The transformation model may be obtained in advance according to the embodiments of the disclosure. The transformation model and the reference color calibration model of the reference MIS may be stored in the memory 150. The processor 200 may receive the transformation model and the reference color calibration model of the reference MIS from the memory 150.

In operation S1403, the processor 200 transforms the measurement data using the transformation model. When the transformation model is a matrix, the processor 200 may convert the measurement data by multiplying the measurement data by the transformation model. When the transformation model is a neural network model, the processor 200 may obtain the transformed measurement data from the output from the neural network model with respect to the measurement data.

In operation S1404, the processor 200 performs the color calibration of the transformed measurement data using the reference color calibration model. The processor 200 may obtain the color data corresponding to the transformed measurement data using the reference color calibration model.

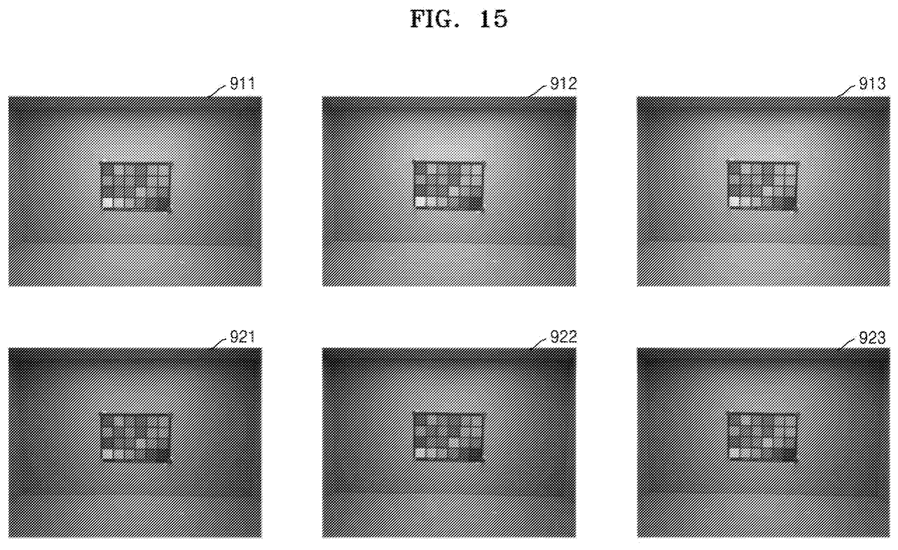

FIG. 15 is a diagram illustrating images captured by a test MIS and a reference MIS according to some embodiments.

An image 911 is obtained by applying the color transformation matrix (that is, reference color calibration model of the reference MIS) to the measurements measured by the reference MIS under the lighting environment using D65 illuminant. An image 912 is obtained by applying a reference color calibration model of the reference MIS to the measurements measured by the test MIS under the lighting environment using D65 illuminant. An image 913 is obtained by transforming the measurements measured by the test MIS under the lighting environment using D65 illuminant using the transformation model, and then, applying the reference color calibration model of the reference MIS to the transformed measurements.

An image 914 is obtained by applying the color transformation matrix (that is, reference color calibration model of the reference MIS) to the measurements measured by the reference MIS under the lighting environment using an A series illuminant. An image 915 is obtained by applying a reference color calibration model of the reference MIS to the measurements measured by the test MIS under the lighting environment using an A series illuminant. An image 916 is obtained by transforming the measurements measured by the test MIS under the lighting environment using an A series illuminant using the transformation model, and then, applying the reference color calibration model of the reference MIS to the transformed measurements.

The image 913 has higher similarity to the image 911 than the image 912. Also, the image 916 has higher similarity to the image 914 than the image 915. As such, the color calibration of the MIS may be effectively performed using the color calibration method suggested by the disclosure.

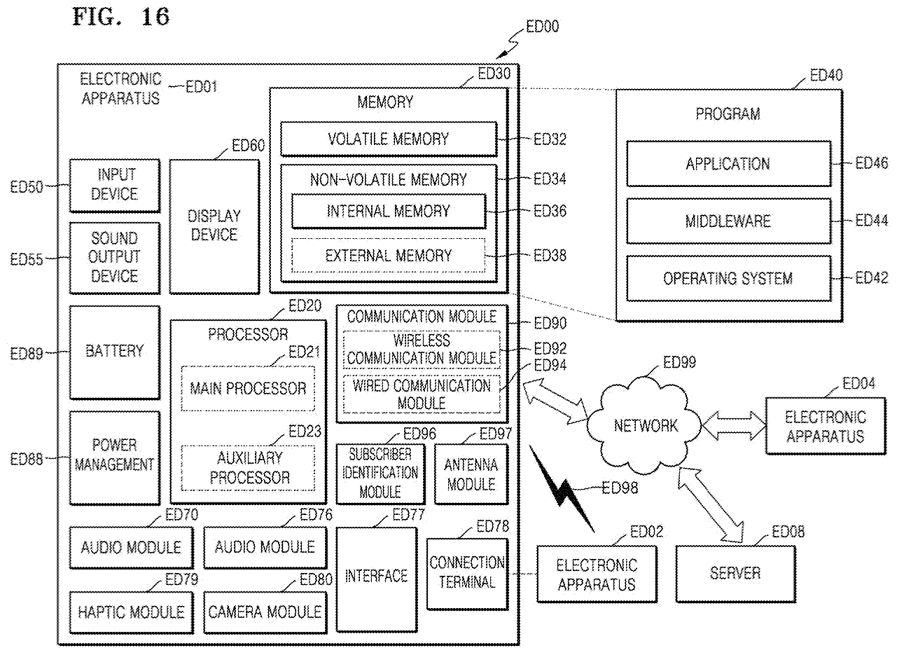

FIG. 16 is a block diagram illustrating an electronic apparatus according to some embodiments. Referring to FIG. 16, in a network environment ED00, the electronic apparatus ED01 may communicate with another electronic apparatus ED02 via a first network ED98 (short-range wireless communication network, etc.), or may communicate with another electronic apparatus ED04 and/or a server ED08 via a second network ED99 (long-range wireless communication network, etc.) The electronic apparatus ED01 may communicate with the electronic apparatus ED04 via the server ED08. The electronic apparatus ED01 may include a processor ED20, a memory ED30, an input device ED50, a sound output device ED55, a display device ED60, an audio module ED70, a sensor module ED76, an interface ED77, a haptic module ED79, a camera module ED80, a power management module ED88, a battery ED89, a communication module ED90, a subscriber identification module ED96, and/or an antenna module ED97. In the electronic apparatus ED01, some (display device ED60, etc.) of the elements may be omitted or another element may be added. Some of the elements may be configured as one integrated circuit. For example, the sensor module ED76 (a fingerprint sensor, an iris sensor, an illuminance sensor, etc.) may be embedded and implemented in the display device ED60 (display, etc.). Also, when the MIS 100 includes a spectral function, some of the functions (color sensor, illuminance sensor) of the sensor module may be implemented by the MIS 100 itself, not by a separate sensor module.

The processor ED20 may control one or more elements (hardware, software elements, etc.) of the electronic apparatus ED01 connected to the processor ED20 by executing software (program ED40, etc.), and may perform various data processes or operations. As a part of the data processing or operations, the processor ED20 may load a command and/or data received from another element (sensor module ED76, communication module ED90, etc.) to a volatile memory ED32, may process the command and/or data stored in the volatile memory ED32, and may store result data in a non-volatile memory ED34. The processor ED20 may include a main processor ED21 (central processing unit, application processor, etc.) and an auxiliary processor ED23 (graphic processing unit, image signal processor, sensor hub processor, communication processor, etc.) that may be operated independently from or along with the main processor ED21. The auxiliary processor ED23 may use less power than that of the main processor ED21, and may perform specified functions.

The auxiliary processor ED23, on behalf of the main processor ED21 while the main processor ED21 is in an inactive state (sleep state) or along with the main processor ED21 while the main processor ED21 is in an active state (application executed state), may control functions and/or states related to some (display device ED60, sensor module ED76, communication module ED90, etc.) of the elements in the electronic apparatus ED01. The auxiliary processor ED23 (image signal processor, communication processor, etc.) may be implemented as a part of another element (camera module ED80, communication module ED90, etc.) that is functionally related thereto.

The memory ED30 may store various data required by the elements (processor ED20, sensor module ED76, etc.) of the electronic apparatus ED01. The data may include, for example, input data and/or output data about software (program ED40, etc.) and commands related thereto. The memory ED30 may include the volatile memory ED32 and/or the non-volatile memory ED34. The non-volatile memory ED34 may include an internal memory ED36 fixedly installed in the electronic apparatus ED01, and an external memory ED38 that is detachable.

The program ED40 may be stored as software in the memory ED30, and may include an operation system ED42, middleware ED44, and/or an application ED46.

The input device ED50 may receive commands and/or data to be used in the elements (processor ED20, etc.) of the electronic apparatus ED01, from outside (user, etc.) of the electronic apparatus ED01. The input device ED50 may include a microphone, a mouse, a keyboard, and/or a digital pen (stylus pen).

The sound output device ED55 may output a sound signal to outside of the electronic apparatus ED01. The sound output device ED55 may include a speaker and/or a receiver. The speaker may be used for a general purpose such as multimedia reproduction or record play, and the receiver may be used to receive a call. The receiver may be coupled as a part of the speaker or may be implemented as an independent device.

The display device ED60 may provide visual information to outside of the electronic apparatus ED01. The display device ED60 may include a display, a hologram device, or a projector, and a control circuit for controlling the corresponding device. The display device ED60 may include a touch circuitry set to sense a touch, and/or a sensor circuit (pressure sensor, etc.) that is set to measure a strength of a force generated by the touch.

The audio module ED70 may convert sound into an electrical signal or vice versa. The audio module ED 70 may acquire sound through the input device ED50, or may output sound via the sound output device ED55 and/or a speaker and/or a headphone of another electronic apparatus (electronic apparatus ED02, etc.) connected directly or wirelessly to the electronic apparatus ED01.

The sensor module ED76 may sense an operating state (power, temperature, etc.) of the electronic apparatus ED01, or an outer environmental state (user state, etc.), and may generate an electrical signal and/or data value corresponding to the sensed state. The sensor module ED76 may include a gesture sensor, a gyro-sensor, a pressure sensor, a magnetic sensor, an acceleration sensor, a grip sensor, a proximity sensor, a color sensor, an infrared (IR) ray sensor, a vivo sensor, a temperature sensor, a humidity sensor, and/or an illuminance sensor.

The interface ED77 may support one or more designated protocols that may be used in order for the electronic apparatus ED01 to be directly or wirelessly connected to another electronic apparatus (electronic apparatus ED02, etc.) The interface ED77 may include a high-definition multimedia interface (HDMI), a universal serial bus (USB) interface, a secure digital (SD) card interface, and/or an audio interface.

The connection terminal ED78 may include a connector by which the electronic apparatus ED01 may be physically connected to another electronic apparatus (electronic apparatus ED02, etc.). The connection terminal ED78 may include an HDMI connector, a USB connector, an SD card connector, and/or an audio connector (headphone connector, etc.).

The haptic module ED79 may convert the electrical signal into a mechanical stimulation (vibration, motion, etc.) or an electric stimulation that the user may sense through a tactile or motion sensation. The haptic module ED79 may include a motor, a piezoelectric device, and/or an electric stimulus device.

The camera module ED80 may capture a still image and a video. The camera module ED80 may include the image capturing apparatus 10 described above, and may include additional lens assembly, image signal processors, and/or flashes. The lens assembly included in the camera module ED80 may collect light emitted from an object that is an object to be captured.

The power management module ED88 may manage the power supplied to the electronic apparatus ED01. The power management module ED88 may be implemented as a part of a power management integrated circuit (PMIC).

The battery ED89 may supply electric power to components of the electronic apparatus ED01. The battery ED89 may include a primary battery that is not rechargeable, a secondary battery that is rechargeable, and/or a fuel cell.

The communication module ED90 may support the establishment of a direct (wired) communication channel and/or a wireless communication channel between the electronic apparatus ED01 and another electronic apparatus (electronic apparatus ED02, electronic apparatus ED04, server ED08, etc.), and execution of communication through the established communication channel. The communication module ED90 may be operated independently from the processor ED20 (application processor, etc.), and may include one or more communication processors that support the direct communication and/or the wireless communication. The communication module ED90 may include a wireless communication module ED92 (cellular communication module, a short-range wireless communication module, a global navigation satellite system (GNSS) communication module) and/or a wired communication module ED94 (local area network (LAN) communication module, a power line communication module, etc.). From among the communication modules, a corresponding communication module may communicate with another electronic apparatus via a first network ED09 (short-range communication network such as Bluetooth, WiFi direct, or infrared data association (IrDA)) or a second network ED99 (long-range communication network such as a cellular network, Internet, or computer network (LAN, wide area network (WAN), etc.)). Such above various kinds of communication modules may be integrated as one element (single chip, etc.) or may be implemented as a plurality of elements (a plurality of chips) separately from one another. The wireless communication module ED92 may identify and authenticate the electronic apparatus ED01 in a communication network such as the first network ED98 and/or the second network ED99 using subscriber information (international mobile subscriber identifier (IMSI), etc.) stored in the subscriber identification module ED96.

The antenna module ED97 may transmit or receive the signal and/or power to/from outside (another electronic apparatus, etc.). An antenna may include a radiator formed as a conductive pattern formed on a substrate (PCB, etc.). The antenna module ED97 may include one or more antennas. When the antenna module ED97 includes a plurality of antennas, from among the plurality of antennas, an antenna that is suitable for the communication type used in the communication network such as the first network ED98 and/or the second network ED99 may be selected by the communication module ED90. The signal and/or the power may be transmitted between the communication module ED90 and another electronic apparatus via the selected antenna. Another component (radio frequency integrated circuit (RFIC), etc.) other than the antenna may be included as a part of the antenna module ED97.

Some of the elements may be connected to one another via the communication method among the peripheral devices (bus, general purpose input and output (GPIO), serial peripheral interface (SPI), mobile industry processor interface (MIPI), etc.) and may exchange signals (commands, data, etc.).

The command or data may be transmitted or received between the electronic apparatus ED01 and the external electronic apparatus ED04 via the server ED08 connected to the second network ED99. Other electronic apparatuses ED02 and ED04 may be the devices that are the same as or different kinds from the electronic apparatus ED01. All or some of the operations executed in the electronic apparatus ED01 may be executed in one or more devices among the other electronic apparatuses ED02, ED04, and ED08. For example, when the electronic apparatus ED01 has to perform a function or service, the electronic apparatus ED01 may request one or more other electronic apparatuses to perform some or entire function or service, instead of executing the function or service by itself. One or more electronic apparatuses receiving the request execute an additional function or service related to the request and may transfer a result of the execution to the electronic apparatus ED01. To do this, for example, a cloud computing, a distributed computing, or a client-server computing technique may be used.

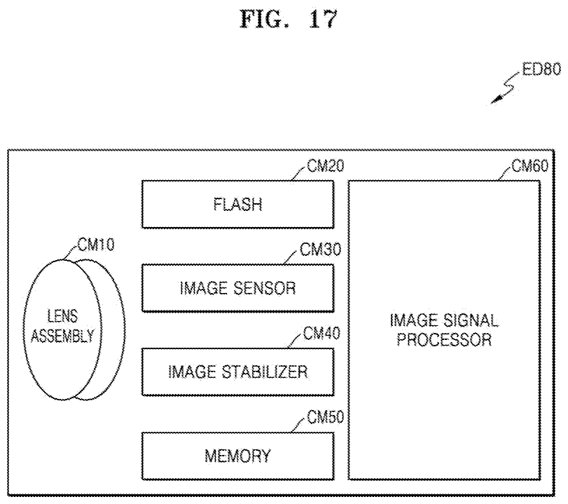

FIG. 17 is a block diagram illustrating a camera module included in the electronic apparatus of FIG. 16 according to some embodiments. The camera module ED80 may include the image capturing apparatus 10 described above, or may have a modified structure therefrom. Referring to FIG. 17, the camera module ED80 may include a lens assembly CM10, a flash CM20, an image sensor CM30, an image stabilizer CM40, a memory CM50 (buffer memory, etc.), and/or an image signal processor CM60.

The image sensor CM30 may include the MIS 100 included in the image capturing apparatus 10 described above. The MIS 100 may obtain an image corresponding to a subject by converting the light emitted or reflected from the subject and transferred through the lens assembly CM10 into an electrical signal. The MIS 100 may obtain a hyperspectral image within an ultraviolet to infrared ray wavelength range.

The image sensor CM30 may further include one or more sensors selected from the image sensors having different properties such as a different RGB sensor, a black and white (BW) sensor, an IR sensor, and a UV sensor, in addition to the MIS 100. Each of the sensors included in the image sensor CM30 may be implemented as a charge coupled device (CCD) sensor and/or a complementary metal oxide semiconductor (CMOS) sensor.

The lens assembly CM10 may collect light emitted from an object, that is, an object to be captured. The camera module ED80 may include a plurality of lens assemblies CM10, and in this case, the camera module ED80 may include a dual camera module, a 360-degree camera, or a spherical camera. Some of the plurality of lens assemblies CM10 may have the same lens properties (viewing angle, focal length, auto-focus, F number, optical zoom, etc.) or different lens properties. The lens assembly CM10 may include a wide-angle lens or a telephoto lens.

The lens assembly CM10 may be configured and/or focusing-controlled such that two image sensors included in the image sensor CM30 may form optical images of an object at the same position.

The flash CM20 may emit light that is used to strengthen the light emitted or reflected from the object. The flash CM20 may include one or more light-emitting diodes (red-green-blue (RGB) LED, white LED, infrared LED, ultraviolet LED, etc.), and/or a Xenon lamp.

The image stabilizer CM40, in response to a motion of the camera module ED80 or the electronic apparatus ED01 including the camera module ED80, moves one or more lenses included in the lens assembly CM10 or the MIS 100 in a predetermined direction or controls the operating characteristics of the MIS 100 (adjusting of a read-out timing, etc.) in order to compensate for a negative influence of the motion. The image stabilizer CM40 may sense the movement of the camera module ED80 or the electronic apparatus ED01 using a gyro sensor or an acceleration sensor arranged in or out of the camera module ED80. The image stabilizer CM40 may be implemented as an optical type.

The memory CM50 may store some or entire data of the image obtained through the MIS 100 for next image processing operation. For example, when a plurality of images are obtained at a high speed, obtained original data (Bayer-patterned data, high resolution data, etc.) is stored in the memory CM50, and a low resolution image is only displayed. Then, original data of a selected image (user selection, etc.) may be transferred to the image signal processor CM60. The memory CM50 may be integrated with the memory ED30 of the electronic apparatus ED01, or may include an additional memory that is operated independently.

The image signal processor CM60 may perform image treatment on the image obtained through the image sensor CM30 or the image data stored in the memory CM50. As described above with reference to FIGS. 1 to 15, the color calibration of the MIS 100 may be performed using the transformation model and the reference color calibration model of the reference MIS. The configuration of the processor 200 for performing the above color calibration may be included in the image signal processor CM60.

The image treatments may include a depth map generation, a three-dimensional modeling, a panorama generation, extraction of features, an image combination, and/or an image compensation (noise reduction, resolution adjustment, brightness adjustment, blurring, sharpening, softening, etc.). The image signal processor CM60 may perform controlling (exposure time control, read-out timing control, etc.) of the elements (image sensor CM30, etc.) included in the camera module ED80. The image processed by the image signal processor CM60 may be stored again in the memory CM50 for additional process, or may be provided to an external element of the camera module ED80 (e.g., the memory ED30, the display device ED60, the electronic apparatus ED02, the electronic apparatus ED04, the server ED08, etc.). The image signal processor CM60 may be integrated with the processor ED20, or may be configured as an additional processor that is independently operated from the processor ED20. When the image signal processor CM60 is configured as an additional processor separately from the processor ED20, the image processed by the image signal processor CM60 undergoes through an additional image treatment by the processor ED20 and then may be displayed on the display device ED60.

The electronic apparatus ED01 may include a plurality of camera modules ED80 having different properties or functions. In this case, one of the plurality of camera modules ED80 may include a wide-angle camera and another camera module ED80 may include a telephoto camera. Similarly, one of the plurality of camera modules ED80 may include a front camera and another camera module ED80 may include a rear camera.

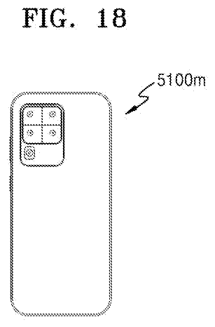

FIGS. 18, 19, 20, 21, 22, 23, 24, 25, 26 and 27 are diagrams illustrating various examples of an electronic device to which an image capturing apparatus is applied according to some embodiments.

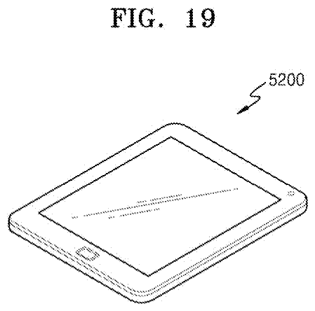

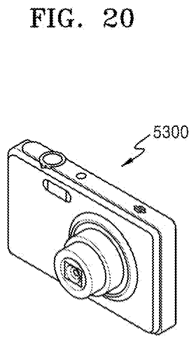

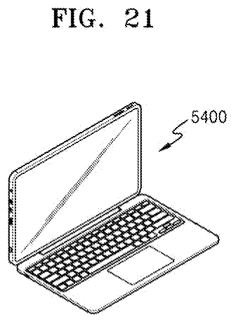

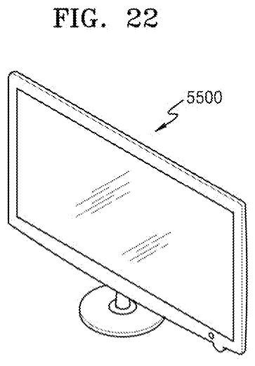

The image capturing apparatus 10 according to the embodiments may be applied to a mobile phone or a smartphone 5100m shown in FIG. 18, a tablet or a smart tablet 5200 shown in FIG. 19, a digital camera or a camcorder 5300 shown in FIG. 20, a laptop computer 5400 shown in FIG. 21, or a television or a smart television 5500 shown in FIG. 22. For example, the smartphone 5100m or the smart tablet 5200 may include a plurality of high-resolution cameras each including a high-resolution image sensor. Depth information of objects in an image may be extracted, out focusing of the image may be adjusted, or objects in the image may be automatically identified using the high-resolution cameras.

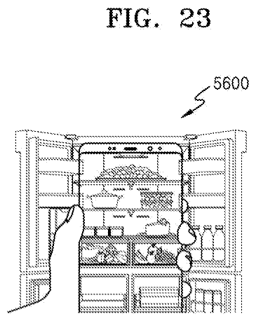

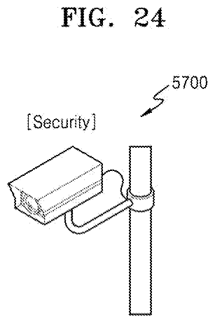

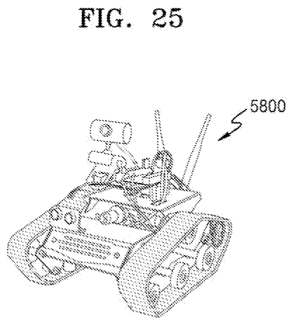

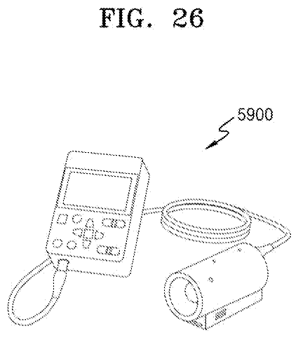

Also, the image capturing apparatus 10 may be applied to a smart refrigerator 5600 shown in FIG. 23, a surveillance camera 5700 shown in FIG. 24, a robot 5800 shown in FIG. 25, a medical camera 5900 shown in FIG. 26, etc. For example, the smart refrigerator 5600 may automatically recognize food in the refrigerator using the image capturing apparatus 10, and may notify the user of an existence of a particular kind of food, kinds of food put into or taken out, etc. through a smartphone. Also, the surveillance camera 5700 may provide an ultra-high-resolution image and may allow the user to recognize an object or a person in the image even in dark environment using high sensitivity. The robot 5800 may be input to a disaster or industrial site that a person may not directly access, to provide the user with high-resolution images. The medical camera 5900 may provide high-resolution images for diagnosis or surgery, and may dynamically adjust a field of view.

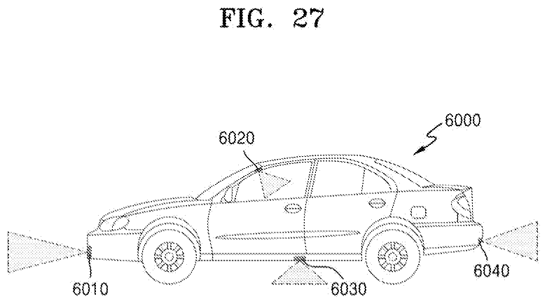

Also, the image capturing apparatus 10 may be applied to a vehicle 6000 as shown in FIG. 27. The vehicle 6000 may include a plurality of vehicle cameras 6010, 6020, 6030, and 6040 at various locations. Each of the vehicle cameras 6010, 6020, 6030, and 6040 may include the image capturing apparatus according to the one or more embodiments. The vehicle 6000 may provide a driver with various information about the interior of the vehicle 6000 or the periphery of the vehicle 6000 using the plurality of vehicle cameras 6010, 6020, 6030, and 6040, and may provide the driver with the information necessary for the autonomous travel by automatically recognizing an object or a person in the image.

While the disclosure has been particularly shown and described with reference to embodiments thereof, it will be understood that various changes in form and details may be made therein without departing from the spirit and scope of the following claims.

What is claimed is:

1. A method of performing color calibration of a multispectral image sensor (MIS), the method comprising:
obtaining test measurement data of at least one color chart that is measured by a test MIS under at least one lighting environment;
obtaining reference measurement data of the at least one color chart that is measured by a reference MIS under the at least one lighting environment, the reference MIS being calibrated in advance; and
generating, based on the test measurement data and the reference measurement data, at least one transformation model configured to transform measurements between the test MIS and the reference MIS.

2. The method of claim 1, wherein the test measurement data comprises a test measurement data matrix comprising rows corresponding to channels of the test MIS and columns corresponding to color samples in the at least one color chart, and
wherein the reference measurement data comprises a reference measurement data matrix comprising rows corresponding to channels of the reference MIS and columns corresponding to the color samples of the at least one color chart.

3. The method of claim 2, wherein the generating of the at least one transformation model comprises:
calculating the at least one transformation model by multiplying the reference measurement data matrix by an inverse matrix of the test measurement data matrix.

4. The method of claim 3, wherein the at least one transformation model is an N×N matrix comprising rows corresponding to N channels in the reference MIS and columns corresponding to N channels of the test MIS.

5. The method of claim 2, wherein the obtaining of the test measurement data comprises obtaining measurement data of P pixels with respect to each of M color samples in the at least one color chart, and
wherein the test measurement data matrix is an N×(M*P) matrix comprising rows corresponding to N channels in the MIS and columns corresponding to the P pixels in each of the M color samples of the at least one color chart.

6. The method of claim 2, wherein the obtaining of the test measurement data comprises obtaining average data of measurement data of P pixels with respect to each of M color samples in the at least one color chart, and
wherein the test measurement data matrix is an N×M matrix comprising rows corresponding to N channels in the MIS and columns corresponding to the M color samples of the at least one color chart.

7. The method of claim 2, wherein the at least one lighting environment comprises a first lighting environment and a second lighting environment,
wherein the obtaining of the test measurement data comprises:
obtaining first test measurement data of the at least one color chart that is measured by the test MIS under the first lighting environment illuminated with a first illuminant;
obtaining second test measurement data of the at least one color chart that is measured by the test MIS under the second lighting environment illuminated with a second illuminant; and
generating the test measurement data matrix based on the first test measurement data and the second test measurement data, and
wherein the obtaining of the reference measurement data comprises:
obtaining first reference measurement data of the at least one color chart that is measured by the reference MIS under the first lighting environment illuminated with the first illuminant;
obtaining second reference measurement data of the at least one color chart that is measured by the reference MIS under the second lighting environment illuminated with the second illuminant; and
generating the reference measurement data matrix based on the first reference measurement data and the second reference measurement data.

8. The method of claim 7, wherein the first illuminant is different from the second illuminant.

9. The method of claim 2, wherein the at least one lighting environment comprises Q lighting environments,
wherein the obtaining of the test measurement data comprises measuring the at least one color chart using the test MIS under each of the Q lighting environments,
wherein the obtaining of the reference measurement data comprises measuring the at least one color chart using the reference MIS under each of the Q lighting environments, and
wherein the at least one transformation model comprises an (N*Q)×(N*Q) matrix comprising rows corresponding to the Q lighting environments and N channels of the reference MIS, and columns corresponding to the Q lighting environments and N channels of the test MIS.

10. The method of claim 1, wherein the at least one transformation model is generated using a neural network based on the test measurement data and the reference measurement data.

11. The method of claim 1, wherein the obtaining of the test measurement data comprises:
obtaining first test measurement data by measuring a first color chart provided at a first position in an image frame of the test MIS; and
obtaining second test measurement data by measuring a second color chart provided at a second position in the image frame of the test MIS,
wherein the obtaining of the reference measurement data comprises obtaining first reference measurement data by measuring the first color chart provided at the first position in an image frame of the reference MIS, and
wherein the generating of the at least one transformation model comprises:
generating, based on the first test measurement data and the first reference measurement data, a first transformation model configured to transform between measurements corresponding to the first position of the test MIS and measurements corresponding to the first position of the reference MIS; and
generating, based on the second test measurement data and the first reference measurement data, a second transformation model configured to transform between measurements corresponding to the second position of the test MIS and measurements corresponding to the first position of the reference MIS.

12. The method of claim 11, wherein the generating of the at least one transformation model further comprises generating a third transformation model corresponding to a third position that is different from the first position and the second position by interpolating the first transformation model and the second transformation model.

13. The method of claim 1, further comprising:
transforming measurement data measured by the test MIS using the at least one transformation model; and
obtaining calibrated color data from the measurement data that is transformed using a reference color calibration model of the reference MIS.

14. A method of performing color calibration in a first multispectral image sensor (MIS), the method comprising:
receiving measurement data measured by the first MIS;
receiving a color calibration model that is generated based on:
a transformation model configured to transform between measurements of the first MIS and a reference MIS that is calibrated in advance, and
a reference color calibration model of the reference MIS; and
performing color calibration of the measurement data based on the color calibration model.

15. The method of claim 14, wherein the color calibration model comprises the transformation model and the reference color calibration model, and
wherein the performing of the color calibration of the measurement data comprises:
transforming the measurement data using the transformation model; and
performing the color calibration of the measurement data that is transformed using the reference color calibration model.

16. The method of claim 14, wherein the transformation model comprises an N×N matrix comprising rows corresponding to N channels in the reference MIS and columns corresponding to N channels of the first MIS.

17. The method of claim 14, wherein the transformation model comprises a neural network model configured to transform measurements between the first MIS and the reference MIS.

18. An image capturing apparatus for performing color calibration, the image capturing apparatus comprising:
a first multi-spectral image sensor (MIS); and
at least one processor configured to:
receive measurement data measured by the first MIS,
receive a color calibration model generated based on:
a transformation model configured to transform between measurements of the first MIS and a reference MIS that is calibrated in advance; and
a reference color calibration model of the reference MIS, and
perform color calibration of the measurement data using the color calibration model.

19. The image capturing apparatus of claim 18, wherein the transformation model comprises an N×N matrix comprising rows corresponding to N channels in the reference MIS and columns corresponding to N channels of the first MIS.

20. The image capturing apparatus of claim 18, wherein the transformation model comprises a neural network model configured to transform measurements between the first MIS and the reference MIS.
